(19) United States
(12) Patent Application Publication
(10) Pub. No.: US 2026/0318501 A1
(43) Pub. Date: Oct. 15, 2026

(54) THERMAL-MECHANICAL DEFORMATION OF A POLYMERIC BODY INTO A CURVED OPTICAL WINDOW

(71) Applicant: SIGNIFY HOLDING B.V., EINDHOVEN (NL)

(72) Inventors: DERK TIEKINK, MIERLO (NL); MARCUS THEODORUS MARIA LAMBOOIJ, EINDHOVEN (NL); JOHANNES PETRUS MARIA ANSEMS, HULSEL (NL); DANIËL ANTON BENOY, GELDROP (NL); FRANCISCUS JACOBUS VOSSEN, HELMOND (NL); HENDRIKUS JOHAN ANDRIE DE VRIES, VELDHOVEN (NL); MARCEL BEIJ, SINT OEDENRODE (NL)

(21) Appl. No.: 19/104,318

(22) PCT Filed: Aug. 7, 2023
(86) PCT No.: PCT/EP2023/071772

§ 371 Date: Feb. 17, 2025

(30) Foreign Application Priority Data
Aug. 15, 2022 (EP) 22190341.2

(51) Int. Cl. F21V 3/06; B29D 11/00; B29K 33/00; B29K 69/00; B29K 483/00; B29K 505/02; B29K 505/08; F21V 3/02; G02B 5/02

(52) U.S. Cl. CPC F21V 3/0625; F21V 3/02; G02B 5/0242; G02B 5/0268; G02B 5/0289; B29D 11/00798; B29K 2033/12; B29K 2069/00; B29K 2483/00; B29K 2505/02; B29K 2505/08; B29K 2995/0029; B29K 2995/003; B29K 2995/0097

(57) ABSTRACT

A system (2000) for the production of a curved optical window (400) from an (elongated) polymeric body (1400), wherein the system (2000) comprises a set of first roller elements (410), an actuator system (500), a heating system (700), and a control system (1500); wherein the first roller elements (410) have rotational axes (A1) (wherein the first roller elements (410) are configured tiltable), wherein the rotational axes (A1) have a controllable mutual angle (α1); wherein the actuator system (500) is configured to control (i) the mutual angle (α1) and (ii) a rotational speed of at least one of the first roller elements (410); wherein the heating system (700) is configured to heat the (elongated) polymeric body (1400); wherein the control system (1500) is configured to control the actuator system (500) and the heating system (700) such that at least part of the (elongated) polymeric body (1400), while being transported between the first roller elements (410), is heated (with the heating system (700)) and bent (by controlling the mutual angle (α1) and the rotational speed) into the curved optical window (400).

### FIELD OF THE INVENTION

The invention relates to a system for the production of a curved optical window from a(n) (elongated) polymeric body. The invention further relates to a method for the production of a curved optical window from a(n) (elongated) polymeric body (using such system). The invention further relates to a curved optical window (such as e.g. produced with such system or according to such method). The invention further relates to a system to generate light. The invention further relates to a lighting device comprising such light generating system.

### BACKGROUND OF THE INVENTION

Lighting systems are known in the art. U.S. Pat. No. 1,025,3944 B1, for instance, describes a light fixture example including a housing, a light source in the housing and a diffuser. The diffuser is supported by the housing at a distance from the source so as to receive light from the source and diffuse the light for illumination. The diffuser has a three-dimensional compound curvature and a perimeter with at least two edges connected at vertices. Each such edge is a two-dimensional plane curve. The at least two edges are not coplanar with each other. In some examples, a back panel of the housing may have a similar three-dimensional compound curvature and perimeter.

### SUMMARY OF THE INVENTION

Light generating devices or system may provide light via an optical window by means of transmission. An optical window may especially be formed from a transparent (or translucent) material via which light may escape, or alternatively may (even) be a diffuser. A diffuser (or “optical diffuser”) is a device that may diffuse light, such as by means of scattering. Particularly, the scattering of light may disrupt the aligned nature of light waves resulting in pseudo-random changes in phase of the light and thus, provide diffuse light. A beam of light may be desired in workplaces such as offices, schools, homes, etc. However, diffuse light may (also) be desired because of the soothing (i.e. less harsh) quality of light compared to exposure to a beam of light. Hence, to that end, lighting systems may be configured with optical windows via which light may escape, which optical windows may be transparent or translucent.

Modern lighting devices may be configured in irregular shapes. The motivation behind the shape of the lighting device may be dependent on the application of the lighting device. For example, in a location such as a school or a workplace, the lighting device may have elongated shapes which may be routed around furniture or specific locations on the walls and ceilings. Such configurations may have practical advantages in directing where the light sources (in the lighting device) are situated. Further, such light sources may (also) provide the advantage of being selective in the location at which light is provided, such as providing more illumination over a desk and less illumination (and diffuse lighting) at the walls of the room (in which the lighting device is placed). Hence, to provide lighting in such lighting devices, an optical window of a complimentary geometry may be used. Such an optical window may further aid in the function of the lighting device by controlling the extent to which the provided light is diffused. For example, the optical diffuser may provide more diffused light to illuminate walls and corridors, as compared to a desk or a workplace (where a beam of light may be outcoupled). Further, it may also be an advantage to use a curved optical window which may be routed around pillars or furniture in a workplace, a school, an office, etc.

However, producing such an optical window (especially a curved optical window) may be challenging. Essentially, optical windows of a desired shape may be cut from a large sheet of polymeric material in a desired shape. This poses many disadvantages, chief among which may be that the remainder of the sheet of polymeric material (from which the optical window is cut) may be wasted. Specific optical windows may require special polymeric materials. It may be expensive to manufacture such polymeric material and hence, it is desired to minimize the wastage of such material. Wastage may be minimized by for example smart cutting or a special tool where multiple designs may be cut from the same polymeric material. However, this may not be possible in all situations and further, designing a system to generate such stencils for cutting the different optical window designs may be cumbersome.

An alternative method of production may be to use injection molding. Molds (or dies) may be created, and these may be used to produce optical windows of a desired shape. However, this method (also) suffers from the drawback of requiring a special setup/tool for injection molding. Further, it may be expensive to create such dies. Each die or mold may be suitable (only) for a specific shape (or design) and an entirely new mold may have to be created to produce a different window. Hence, this may (only) be commercially viable when such optical windows are produced in large quantities.

Hence, it is an aspect of the invention to provide an alternative system for the production of a curved optical window from an (elongated) polymeric body, which preferably further at least partly obviates one or more of above-described drawbacks. The present invention may have as object to overcome or ameliorate at least one of the disadvantages of the prior art, or to provide a useful alternative.

According to a first aspect, the invention provides a system for the production of a curved optical window from an (elongated) polymeric body. Especially, the system may comprise a set of first roller elements (or “roller elements”), an actuator system, and a control system. Optionally, the system may comprise a heating system. In embodiments, the first roller elements may have rotational axes (A1) (herein the first roller elements may be configured tiltable). Especially, the rotational axes (A1) may have a controllable mutual angle (α1). In embodiments, the actuator system may be configured to control (i) the mutual angle (α1) and (ii) a rotational speed of at least one of the first roller elements. In embodiments, the optional heating system may be configured to heat the (elongated) polymeric body. Especially, the control system may be configured to control the actuator system such that at least part of the (elongated) polymeric body, while being transported between the first roller elements, is bent (especially by controlling the mutual angle (α1) and the rotational speed) into the curved optical window. More especially, the control system may be configured to control the actuator system and the heating system such that at least part of the (elongated) polymeric body, while being transported between the first roller elements, is heated (with the heating system) and bent (especially by controlling the mutual angle (α1) and the rotational speed) into the curved optical window. Hence, in specific embodiments, the invention may provide a system for the production of a curved optical window from an (elongated) polymeric body, wherein the system comprises a set of first roller elements, an actuator system, a heating system, and a control system; wherein the first roller elements have rotational axes (A1) (wherein the first roller elements are configured tiltable), wherein the rotational axes (A1) have a controllable mutual angle (α1); wherein the actuator system is configured to control (i) the mutual angle (α1) and (ii) a rotational speed of at least one of the first roller elements; wherein the heating system may be configured to heat the (elongated) polymeric body; wherein the control system is configured to control the actuator system and the heating system such that at least part of the (elongated) polymeric body, while being transported between the first roller elements, is heated (with the heating system) and bent (especially by controlling the mutual angle (α1) and the rotational speed) into the curved optical window. Hence, in embodiments, the invention may provide a system for mechanical deformation, especially thermal-mechanical deformation, of a polymeric body into a curved optical window.

With such a system, the amount of polymeric material required to produce the curved optical window is significantly reduced as compared to cutting the curved optical window from a sheet of polymeric material. Since the curved optical window is produced by transporting the (elongated) polymeric body through the first roller elements, almost the entire volume (or especially the entire volume) of the (elongated) polymeric body is used and thus, wastage of polymeric material is limited to a minimum. Furthermore, the limited wastage of polymeric materials reduces the cost of producing such curved optical windows.

Additionally, in the system described above, no special tools may necessarily be employed. No specific tools for generating a suitable stencil for cutting curved optical windows, or for injection molding are required. This may further reduce the cost of manufacturing curved optical windows.

Further, the advantage of using such a system may be that the shape of the curved optical window is configurable. For instance, the curvature of the curved optical window, and the thickness of the curved optical window may be varied by controlling the rotational speed of the one or more first roller elements, controlling the mutual angle (α1), and the extent of heating provided. This may be economically advantageous over generating a new die (such as in the case of injection molding).

Yet further, the configurability of the geometric construction of the curved optical window, in addition to the ease of manufacturing, and the low cost of manufacturing provides the benefit of making custom curved optical windows. This is particularly advantageous as the curved optical windows may be used in unique lighting systems, which are unique to the location at which they are used (such as in a specific building). Hence, unique curved optical windows may be produced without the necessity for batch production in large quantities or a requirement for a large inventory space to accommodate manufactured optical windows.

As mentioned before, in embodiments, the invention may provide a system for the production of a curved optical window from an (elongated) polymeric body. The curved optical window may be produced from a plurality of different polymeric source materials. Here, polymeric source material refers to a polymeric material from which a curved optical window may be produced. Further, polymeric material may refer to the material of the (elongated) polymeric body and the curved optical window. Hence, especially, the system may produce a curved optical window from an elongated polymeric body, here elongated may refer to a polymeric body that may essentially be configured straight (or with a rectilinear axis). Further, in embodiments, the polymeric body may be coiled, such as in a spool. Especially, the curved optical window may be produced from another curved optical window (such as with a different curvature and/or thickness). Yet further, in embodiments, the curved optical window may (also) be produced from a solid block of polymeric material. The composition of said polymeric material is discussed further below.

In embodiments, the first roller elements may have rotational axes (A1). Roller elements here refers to elements which may be rotated about an axis i.e. the rotational axes (A1). The system, in embodiments, may comprise a plurality of different first rollers, such as for instance, two first roller elements. However, especially, more roller elements may (also) be configured. The first roller elements in embodiments, may have a cylindrical geometry with the axis of the cylinder aligned with the rotational axis (A1). However, in embodiments, other configurations such as a conical roller element may be possible, wherein the radius of the conical element may vary along the rotational axis (A1). Note that, the mutual angle (α1) is controllable even in embodiments comprising non-cylindrically shaped first roller elements.

Hence, the term “first roller elements” may especially refer to two (or more) rollers, having rotational axes which have a mutual angle (α1) which is controllable.

The term “first roller elements” may also refer to one or more sets of each two roller elements, wherein the two roller elements of each set have rotational axes which have a mutual angle (α1) which is controllable. The mutual angle of different sets may in embodiments individually be controlled.

In embodiments, these rollers may be used to achieve specific patterns or shapes of the curved optical window. Further, in embodiments, the first roller elements may have a wedge shape, or a barrel shape, or other curved profile shapes. Especially, the first roller elements may be selected individually in embodiments i.e. the “first” first roller element may have a different shape compared to “another” first roller element. Yet further, the roller element may (also) be faceted i.e. the roller element may have polygonal cross-section such as a cylinder with at least 5 faces, such as at least 10 faces, such as at least 50 faces. Especially, however, in embodiments the roller elements are cylindrical.

The roller elements may have essential flat surfaces. However, on one or more of the roller elements, a surface texture may be available. Hence, a variety of surface textures of the curved optical window may be achieved by using the one or more aforementioned roller elements. For example, surface textures (or patterns) may be in the form of sinusoidal contours, pyramidal patterns, etc. In addition to the first roller elements, “additional” roller elements may be configured. Note that, in embodiments, the one or more first roller elements may differ in geometry. Further, the one or more “additional” roller elements may (also) differ in geometry. The additional roller elements may assist in shaping the curved optical window into a desirable shape or configuration.

Particularly, in embodiments, the radius of curvature of the curved optical window may be controlled in dependence of the rotational speed (and/or torque) of the one or more first roller elements, more especially at least by the mutual angle of the rotational axes of the first roller elements.

In embodiments, the first roller elements may be configured tiltable. In embodiments, there may be two first roller elements which may be oriented along their rotational axes (A1). Therefore, the two rotational axes (A1) and hence, the two first roller elements may be configured at an angle relative to each other. Further, in embodiments, the angle between the two first roller elements may be controllable i.e. they may be varied. Hence, especially, the rotational axes (A1) may have a controllable mutual angle (α1). The (elongated) polymeric body may be transported between the two first roller elements configured at the mutual angle (α1), thus curving the (elongated) polymeric body into the curved optical window. Therefore, the curvature of the curved optical window may especially be controlled in dependence of the controllable mutual angle (α1). Furthermore, the cross-section of the curved optical window may (also) be modified as a result of being transported between the two first roller elements. Further information on the geometric properties of the curved optical window is discussed further below. Especially, the (elongated) polymeric body may be deformed by the first roller elements.

In embodiments, the system may comprise one or more actuators. These actuators, in embodiments, may perform a plurality of actions. Especially, the actuators may be functionally coupled to the first roller elements. Here, functionally coupled refers to a mechanical connection wherein the rotational speed and torque from the actuators is transferred to the one or more first roller elements. Hence, in embodiments, the actuators may rotate the first roller elements at a controllable angular speed. Further, in embodiments, the actuators may control the mutual angle (α1) between the first roller elements. Yet further, the torque applied on the first roller elements may especially (also) be controllable.

In embodiments, each of the first roller elements may be functionally coupled to a unique actuator. Alternatively, in embodiments, the “first” first roller elements may be functionally coupled to the “second” first roller elements, and the “second” first roller element may (also) be controllable by mechanical coupling to a single actuator. Here, mechanical coupling may refer to connection such as via a set of gears or belts. Hence, the mechanical energy from a single actuator may be transferred to one or more of the first roller elements.

Further, in embodiments, the first roller elements may especially be configured such that there is no slip between the surface of the first roller elements and the surface of the (elongated) polymeric body (or the polymeric material). Here “no slip” refers to zero relative velocity at any point of contact between the first roller element and the curved optical window (or the (elongated) polymeric body). Therefore, the rotation of the first roller elements may transform the (elongated) polymeric body configured upstream of the first roller elements to the curved optical window downstream of the first roller elements. Here, transform may refer to simply a transportation of (elongated) polymeric body, it may (also) refer to deformation of the (elongated) polymeric body, and it may (also) refer to extrusion of the (elongated) polymeric body.

Especially, the rotational speed (and/or torque) may be selected such that there is no slip between the polymeric material and the first roller elements. The speed at which the polymeric body may be transported downstream of the first roller elements may be dependent on how malleable (or ductile) the polymeric body may be. Hence, this may imply that the controllable rotational speed (and/or torque) may be selected in dependence of the temperature of the polymeric body.

The terms “upstream” and “downstream” relate to an arrangement of items or features relative to the first roller elements, wherein relative to a position of the first roller elements, a position closer to the (elongated) polymeric body is “upstream”, and a position closer to the curved optical window is “downstream”.

Further, in embodiments, the actuators may be configured to extrude the (elongated) polymeric body between the first roller elements i.e. the actuator may perform a pulling action (or pushing action (or “feeding”)) the (elongated) polymeric body, which provides a curved optical window as it is extruded between the first roller elements. Note that there may be embodiments where only such actuators (that pull or push polymeric material) may be present, with the absence of actuators that rotate the first rolling elements. Hence, the first roller elements in these embodiments may be rotated as a result of no slip between the polymeric material and the first roller elements. As mentioned before, embodiments of the system may comprise (only) actuators that rotate the first roller elements without any additional actuators configured push (or pull) the polymeric material. As an additional function, embodiments of the system may (also) comprise actuators configured to translate (or transport) the first roller elements upstream (as opposed to transporting the polymeric material downstream). Yet further, in embodiments, a combination of actuators that transport the first roller elements upstream and actuators that transport the (elongated) polymeric body downstream simultaneously may be possible. Hence, in this way, many embodiments may be configured which perform the function of transporting the polymeric material and the first roller elements relative to one another.

Furthermore, in embodiments, in addition to the actuators described above, there may be additional actuators to control the rotation of the one or more additional roller elements. Note that the actuators are not limited (only) to transporting roller elements (first roller elements and additional roller elements). Rather, in embodiments, the actuators may (also) be used control the position of the heating elements comprised by the heating system (see further below). For example, the actuators may especially be used to control the position of optional blowers.

Hence, in summary, the system may comprise one or more, such as especially a plurality of, actuators that may perform the function of providing the curved optical window with the desired geometry. Further, these one or more actuators may be comprised by an actuator system. The actuator system may especially control each of the individual actuators comprised by the actuator system. Therefore, in embodiments, the actuator system may be configured to control (i) the mutual angle (α1) and (ii) a rotational speed of at least one of the first roller elements. Additionally, in embodiments, the actuator system may control the rotational speed (and/or torque) of the first roller elements individually. Hence, the rotational speed (and/or torque) of one of the first roller elements may be configured different to the rotational speed (and/or torque) of one of the other first roller elements. Note that, in such embodiments, the rotational speed (and/or torque) may be selected to facilitate the transport of the polymeric body downstream of the first roller elements, such that there is no slip between the first roller elements and the (elongated) polymeric body.

In embodiments, the system may comprise the heating system configured to heat the (elongated) polymeric body. Heating may make the polymeric material more malleable, and/or may (also) make the polymeric material more ductile. Hence, heating may provide the advantage of reducing the energy input required from the actuators for transforming the (elongated) polymeric body into the curved optical window. Especially, the heating system may be configured to heat the polymeric material to a processing temperature Tₚ, wherein Tₚ is a temperature higher than the temperature at which the polymeric material transforms from a (relatively more) brittle to a (relatively more) ductile (or malleable) material. Heating, in embodiments, may be provided via the first roller elements i.e. the heating system may heat the first roller elements, and thus heat the polymeric material.

Further, in embodiments, the heating system may comprise blowers. Especially, the blowers may be configured to blow hot air on the polymeric material. In embodiments, these blowers may be configured in the vicinity of the first roller elements. Hence, the blowers may be configured upstream of the first roller elements (closer to the (elongated) polymeric body). Alternatively, in embodiments, the blowers may be configured downstream of the first roller elements (closer to the curved optical window). Especially, the heating system may comprise more than one blower, wherein the location of the one or more blowers may be individually controlled. Yet further, in embodiments, the blowers may be configured to blow hot air on the first roller elements. Furthermore, in embodiments, the heating system may comprise more than one blower.

Alternatively or additionally, the heating system may comprise one or more electrical heaters. Such heaters may be used to generate IR radiation for heating the polymeric material.

It follows hence, in embodiments, that the first roller elements may comprise a material that may be heat resistant. Alternatively, in embodiments, the first roller elements may comprise an electrically conductive material. Such material may especially provide the advantage of heating the first roller elements by passing a current through them. Hence, in embodiments, the first roller elements may be heated by blowing hot air on the first roller elements, or by heating the first roller elements by passing a current through the first roller elements, or by a combination thereof.

In embodiments, the one or more systems such as the heating system and the actuator system may be individually controlled by the control system. Hence, in this way, the control system may especially control the actuator system and hence, control the mutual angle (α1), the rotational speed and/or the torque of the first roller elements. Additionally or alternatively, in embodiments, the control system may control the heating system and thus, the heat provided to the polymeric material, or the first roller elements, or both. Therefore, in embodiments, the control system may be configured to control the actuator system and the heating system such that at least part of the (elongated) polymeric body, while being transported between the first roller elements, is heated (with the heating system) and bent (especially by controlling the mutual angle (α1) and the rotational speed of the first roller elements) into the curved optical window.

Hence, in summary, the system may especially comprise a set of first roller elements, an actuator system, a heating system, and a control system.

In embodiments, the (elongated) polymeric body, having a thickness (h₁), while being transported between the first roller elements, may be heated and bent into the curved optical window having a radius (r1), a maximum height (hₓ) at a minimum radius (rₘ) smaller than the radius (r₁), and a minimum height (hₘ) at a maximum radius (rₓ) larger than the radius (r₁). In embodiments, curved optical window may have a radius (r₁), however this does not limit the curved optical window to a circular geometry.

As mentioned before, the curved optical window may especially be curved in one or more direction along the axis of the curved polymer diffuser. One way of defining the axis of the optical window may be that the axis is a line passing through the centroid of the cross-section of the curved optical window along the (entire) length of the curved optical window. The curvature of the axis (and hence, the optical window) may, in embodiments, be in two directions i.e. the curved optical window may be curved upwards or downwards (when viewed from the front), or may be curved to the left or the right (when viewed from above). Further, in embodiments, the curved optical window may have a meandering configuration, wherein the axis of the curved optical window may comprise a number of curves such as in the trajectory of a meandering river. For clarity, “front” refers to a direction of viewing the curved optical window in the direction in which the curved optical window is extruded or transported i.e. if a viewer were to view the system, the curved optical window would be transported towards the viewer (in a front view). Hence, the other directional views such as top, bottom, left and right, may be defined in relation to the front view.

Hence, in embodiments, the radius of curvature (r₁) of the curved optical window may vary along its axis. A cross-section (perpendicular to the axis or when viewed from the front) of the curved optical window may, in embodiments, be defined by a left edge, a right edge, a top surface and a bottom surface. The radius of curvature (r₁) may especially be measured from a point in the center of the cross-section. This may, in embodiments, be the midpoint between the left edge and right edge. Further, the shape of the cross-section of the curved optical window may, in embodiments, be polygonal. However, in other embodiments, the shape of the cross-section of the curved optical window may be other than polygonal such as a curved cross-section or an irregular (or amorphous) shaped cross-section. Hence, in such embodiments, the radius may be measured from the centroid of the cross-section. In embodiments, the edges or surfaces of the curved optical window may (also) be curved. Note that here, the curvature of the cross-section is described which is different from the curvature of the axis of the curved optical window.

In the cross-section, the two edges (left and right) may have a radius of curvature (rₓ) larger than the radius of curvature (r₁), and a radius of curvature (rₘ) smaller than the radius of curvature (r₁), respectively. Further, in embodiments, the height (or thickness) of the curved optical window may vary over the cross-section i.e. on moving from one edge to the other, the height of the curved optical window may vary. In embodiments, the curved optical window may have a minimum height (hₘ) at a maximum radius of curvature (rₓ). Further, in embodiments, the curved optical window may have a maximum height (hₓ) at a minimum radius of curvature (rₘ). However, in embodiments, the following may apply wherein 0.95≤hₓ/h₁≤1, and wherein 0.7≤hₘ/hₓ<1. Notice that, especially, hₓ may be equal to h₁ i.e. the maximum thickness of the curved optical window may be equal to thickness of the (elongated) polymeric body. However, in contrast, the minimum thickness may especially be lower than the thickness of the (elongated) polymeric body. In embodiments, the variation of the thickness (or height) of the curved optical window may be within 30%, especially 15%, such as 5%. Variation here refers to the difference between the maximum and minimum height of the curved optical window.

Hence, in embodiments, the control system may be configured to control the actuator system and the heating system such that at least part of the (elongated) polymeric body, having a thickness (h₁), while being transported between the first roller elements, is heated and bent into the curved optical window having a radius (r₁), a maximum height (hₓ) at a minimum radius (rₘ) smaller than the radius (r₁), and a minimum height (hₘ) at a maximum radius (rₓ) larger than the radius (r₁); wherein 0.9≤hₓ/h₁≤1, and wherein 0.75hₘ/hₓ<1. Further, in embodiments, the maximum height of the curved polymer diffuser may be equal to the height of the (elongated) polymeric body i.e. hₓ/h₁=1. Further, in embodiments, the minimum height of the curved optical window may vary in the range according to 0.75≤hₘ/hₓ≤1, such as 0.8≤hₘ/hₓ≤1, especially 0.85≤hₘ/hₓ≤0.95. Especially, the (elongated) polymeric body may have the thickness (h₁) selected from the range of 1-10 mm, such as 1-6 mm, especially 1-3 mm. Further, in embodiments, the length first roller elements may be equal to the width (W) of the curved optical window, wherein the width (W) of the roller may be defined as rₓ-rₘ.

In embodiments, the mutual roller angle (α1) may be controllable between +5 °, such as +2 °, especially +1 °, and −5 °, such as −2 °, especially −1 ° relative to parallel configured rotational axes (A1). Especially, there may be more than one first roller elements such as two first roller elements. Hence, the mutual angle (α1) may be measured in the anti-clockwise direction from the “first” first roller element to the “second” first roller element. Note that the phrase “controllable between an angle” refers to controlling the mutual roller angle (α1) between 0 ° and α1. Hence, in embodiments, the mutual roller angle (α1) may be controllable according to 0 °≤α1≤+5 °, such as 0 °≤α1≤+2 °, especially 0 °≤α1≤+1 °. The meaning of the signs “+” and “−” are described below.

It must be noted that the first roller element may have a base and a tip, wherein the “base” refers to the part of the first roller element which may be close to the mechanical connection between the first roller element and one or more actuators, and the “tip” refers to the end of the first roller element (i.e. a part on the extremity of the roller along the rotational axis A1) away from the location where the actuators are connected to the first roller elements. The distinction between the base and the tip is useful in defining the mutual angle (α1). Especially, the mutual angle (α1) is measured positive if the rotational axes (A1) of the “first” and “second” first roller elements intersect at a point closer to the base (than the tip) of the first roller elements. Similarly, the mutual angle (α1) is measured negative if the rotational axes (A1) of the “first” and “second” first roller elements intersect at a point closer to the tip (than the base) of the first roller elements.

The curved optical window may be curved towards the right or the left (when viewed from the front) in dependence of a positive or negative mutual roller angle (α1). Especially, the curved optical window may curve away from the edge with the minimum height (hₘ). This is because the excess polymeric material in the part of the (elongated) polymeric body that undergoes a reduction in height may be accommodated in the part of the curved optical window that has a larger radius. Hence, if the curved optical window has a minimum height (hₘ) on the left side (when viewed from the front), the curved optical window may be curved towards the right, and vice versa. Therefore, by varying the mutual angle (such as between positive and negative mutual roller angles (α1)), the direction in which the curved optical window is curved may be controlled. Hence, the sign “+” and “−” are indicative of the configuration of the roller elements and are not indicative of positive/negative angular measurements.

In embodiments, the (elongated) polymeric body may comprise a polymeric material with scattering particles embedded therein. Hence, the curved optical window, in embodiments, may (also) comprise scattering particles. Such particles may especially scatter an incident beam of light and hence, provide diffuse light. Hence, in embodiments, the curved optical window may comprise a curved polymeric diffusor.

The obtained effect is an improved diffuser (for a light generating system) in terms of optical performance (e.g. in terms of shape, appearance and/or diffusivity).

In embodiments, the system may comprise a control system. Especially, the control system may be configured to control the actuator system such that the radius (r1) is at least 100 mm, such as at least 150 mm, such as at least 300 mm, especially at least 1000 mm, such as 10000 mm. The control system may especially control the actuator system and hence, may control the actuators. Hence, the control system may be used change the radius of curvature (r1) by varying the (i) rotational speed of the first roller elements, or (ii) torque of the first roller elements, or (iii) the mutual angle (α1) between two first roller elements, or a combination thereof. Especially, the radius of curvature (r1) of the curved optical window may be varied during operation by varying the mutual angle (α1). Hence, in embodiments, the curved optical window may have different radii (r1) along the axis of the curved optical window. Yet further, in embodiments, the control system may also be used to vary the direction of curvature of curved optical window.

In embodiments, the system may further comprise one or more guiding elements. Especially, the guiding elements may be configured at one or both sides of the set of first roller elements. Here, sides of the roller elements may be analogous to the sides (or edges) of the curved optical window. Hence, the guiding elements may especially be configured on the left side or right side of the curved optical window (when viewed from the front). Especially, the guiding elements may contact the curved optical window at the sides such that there is no slip between the curved optical window and the guiding elements. More especially, the one or more guiding elements may comprise guiding rollers. Yet further, the one or more guiding elements may contact the first roller elements to form an opening of a polygonal shape. Typically, in embodiments, this may be in the shape of a trapezoid i.e. a planer cross-section with one edge smaller than the other, however, other shapes may also be conceived in embodiments. In embodiments, the polymeric body may be extruded downstream via this opening such that the curved optical window has the same cross-section as the opening described herein.

In embodiments, the first roller elements may transform the (elongated) polymeric body by contacting it from a plane above and below the polymeric material (when viewed form the front). However, this provides limited control in shaping the left and the right edge (when viewed from the front) of the curved optical window. Hence, in embodiments, the one or more guiding elements configured at the sides of the curved optical window may provide a curved optical window with especially flat edges or sides. However, in other embodiments, the guiding elements may also have other shapes (for example a spindle shape) which may (also) provide curved optical windows with curved sides. Yet further, embodiments may comprise a combination of different shaped guiding elements. Hence, in embodiments, the curved optical window may comprise a side that is flat and another side that is curved. Hence, in this way, embodiments of the system may be conceived wherein the guiding elements may be selected such that a plurality of cross-sectional shapes are realized. Further, such embodiments prevent additional polymeric material from accumulating in the sides of the curved optical window. In embodiments, the one or more guiding elements may be configured such that there is no slip between the guiding elements and the curved optical window (or (elongated) polymeric body).

In embodiments, the first roller elements and/or the actuator system may be configured such that the rotational speeds of the first roller elements of the system, when in operation, are the same. In embodiments, the speed of the first roller elements may influence the vertical direction in which the curved optical window may be curved (when viewed from the front). More material may be transported between the first roller elements at higher rotational speeds. Hence, in embodiments, in a configuration wherein the “first” first roller element is configured below the “second” first roller element, the curved optical window may be curved upwards (when viewed from the front) by increasing the rotational speed of the “first” first roller element compared to the “second” first roller element. Similarly, the curved optical window may especially be curved downwards by increasing the rotational speed of the “second” first roller element relative to the “first” first roller element. The extent of the curvature may, in embodiments, be further controlled by the relative difference in speed between the (two) first roller elements. Therefore, in embodiments, the curvature of the curved optical window in the vertical direction (when viewed form the front) may be controlled in dependence of the speed of the first roller elements. Hence, in embodiments, an essentially planar curved optical window may be provided by configuring the rotational speed of the first roller elements to be the same during operation.

Especially, in embodiments the first roller elements may have substantially the same dimensions, especially in terms of diameter. Hence, the first roller elements and/or the actuator system may be configured such that the rotational speeds of the first roller elements of the system, when in operation, are the same. Would however, the first roller elements have different dimensions, especially in terms of diameters, in embodiments the first roller elements and/or the actuator system may be configured such that the angular speeds of the first roller elements of the system, when in operation, are the same. In this way, the translational speeds at both faces of the polymeric body between the first roller elements may essentially be the same.

As mentioned before, the polymeric material may be ductile at a temperature larger than a transition temperature Tₜ. Ductility and malleability are the properties of a material that define a materials susceptibility to be drawn into wires, but more specifically to undergo plastic deformation. Especially, the polymeric material may be ductile and malleable when heated. The transition temperature Tₜ may especially be a temperature beyond which the polymeric material may be sufficiently plastic such that it may be shaped into the curved optical window using the system. Hence, in embodiments, the heating system may be configured to heat the polymeric material (i.e. the (elongated) polymeric body) to a temperature larger than Tₜ. Further, in embodiments, the heating system may be configured to heat the first roller elements. Optionally, in embodiments, the heating system may (also) be configured to heat the one or more guiding elements. Hence, in this way heat may be transferred by conduction from the first roller elements (and/or the guiding elements) to the (elongated) polymeric body. Alternatively, as mentioned before, the heating element may (also) comprise blowers which may be configured to blow hot gas on to the surface of the one or more first rollers, or the guiding elements, or the polymeric material, or a combination thereof. In embodiments, the transition temperature Tₜmay be the glass transition temperature.

In a further aspect, the invention may provide a method for the production of a curved optical window from an (elongated) polymeric body, using a set of first roller elements. Especially, the first roller elements may have rotational axes (A1). More especially, the first roller elements may be configured tiltable, wherein the rotational axes (A1) have a mutual angle (α1). In embodiments, the angle between the two first roller elements may be controllable i.e. it may be varied. Especially, the method may comprise transporting the (elongated) polymeric body between the two first roller elements configured at the mutual angle (α1), thus curving the (elongated) polymeric body into the curved optical window. Further, in embodiments, the method may comprise controlling the radius of curvature of the curved optical window in dependence of the rotational speed (and/or torque) of the one or more first roller elements. In embodiments, the method may comprise varying the rotational speed (and/or torque) of the first roller elements individually.

Further, in embodiments, the method may comprise heating the polymeric material, such as to a transition temperature Tₜ. Especially, the method may comprise heating the first roller elements, or the additional roller elements, or both. Additionally or alternatively, the method may comprise heating the first roller elements, and/or the additional roller elements, and/or the polymeric material by means of blowers (which blow hot gas). Heating the polymeric material to a processing temperature Tₚ may make the polymeric material ductile, hence making if susceptible to deformation. In embodiments, the method may comprise transporting the (elongated) polymeric body between the first roller elements and heating the (elongated) polymeric body between the first roller elements. Especially, the method may comprise controlling (i) the mutual angle (α1) and (ii) a rotational speed of at least one of the first roller elements, to provide the curved optical window.

In embodiments, the method may comprise producing a curved optical window from an (elongated) polymeric body. Further, in embodiments, the method may especially comprise providing a curved optical window from a coil (or spool) of polymeric material, another curved optical window, or a solid block of polymeric material.

Hence, in specific embodiments, the invention may provide a method for the production of a curved optical window from an (elongated) polymeric body, using a set of first roller elements; wherein the first roller elements have rotational axes (A1) (wherein the first roller elements are configured tiltable), wherein the rotational axes (A1) have a controllable mutual angle (α1); wherein the method comprises transporting the (elongated) polymeric body between the first roller elements and heating the (elongated) polymeric body between the first roller elements, controlling (i) the mutual angle (α1) and (ii) a rotational speed of at least one of the first roller elements, to provide the curved optical window.

As mentioned above, in embodiments, the method may comprise transporting the (elongated) polymeric body (having a thickness (h₁)) between the first roller elements and heating the (elongated) polymeric body between the first roller elements, controlling (i) the mutual angle (α1) and (ii) the rotational speed of at least one of the first roller elements, to provide the curved optical window having a radius (r1), a maximum height (hₓ) at a minimum radius (rₘ) smaller than the radius (r₁), and a minimum height (hₘ) at a maximum radius (rₓ) larger than the radius (r₁). Further, especially, the following may apply wherein 0.9≤hₓ/h₁≤1, and wherein 0.7≤hₘ/hₓ<1. Yet further, in embodiments, the method may comprise providing the curved optical window such that hₓ/h₁=1 and 0.85≤hₘ/hₓ≤0.95.

Hence, in embodiments, the method may comprise transporting the curved optical window such that it may have a minimum height (hₘ) at a maximum radius of curvature (rₓ) and a maximum height (hₓ) at a minimum radius of curvature (rₘ).

Further, in embodiments, the method may comprise providing the curved optical window such that the maximum height of the curved polymer diffuser may be equal to the height of the (elongated) polymeric body i.e. hₓ/h₁=1. Especially, the method may comprise providing a curved optical window wherein the minimum height of the curved optical window may vary in the range according to such as 0.7≤hₘ/hₓ≤1, especially 0.85≤hₘ/hₓ≤1, such as 0.85≤hₘ/hₓ≤0.95.

Furthermore, the method may comprise providing the curved optical window such that the (elongated) polymeric body may have the thickness (h₁) selected from the range of 1-10 mm, such as 1-6 mm, especially 1-3 mm. In embodiments, the method may comprise limiting the variation in the thickness (or height) of the polymeric material to within 30%, especially 20%, such as 10%. Variation here refers to the difference between the maximum and minimum height of the curved optical window. Further, in embodiments, the method may comprise providing the curved optical window with a fixed width (W), such as W=rₓ-rₘ by selecting the length of the first roller elements equal to the width (W) of the curved optical window. As mentioned before, in embodiments, the length first roller elements may be equal to the width (W) of the curved optical window, wherein the width (W) of the roller may be defined as rₓ-rₘ.

In embodiments, the method may comprise controlling the mutual roller angle (α1) between +5 °, such as +2 °, especially +1 °and −5 °, especially −2 °, such as −1 ° relative to parallel configured rotational axes (A1). The definitions of the positive and negative angles are described further above. Hence, in embodiments, the method may comprise controlling the direction of curvature of the curved optical window be varying between the positive and negative mutual roller angle (α1). Furthermore, the method may comprise controlling the radius of curvature of the curved optical window by varying the mutual roller angle ((α1)). A larger mutual roller angle (α1) may result in a smaller radius (r1) of the curved optical window.

Hence, in embodiments, the method may comprise controlling the mutual angle (α1) and the rotational speed of at least one of the first roller elements to provide the radius (r1) of at least 100 mm, such as at least 150 mm, such as at least 300 mm, especially at least 1000 mm, such as at least 10000 mm. Especially, Especially, the method may comprise varying during operation the mutual angle (α1) and hence, provide the curved optical window having different radii (r1) along the axis of the curved optical window.

In embodiments, the method may further comprise using one or more guiding elements configured at one or both sides of the set of first roller elements. Especially, the one or more guiding elements may comprise guiding rollers. In embodiments, the method may comprise using the one or more guiding elements configured at the sides of the curved optical window to provide a curved optical window with especially flat edges or sides. However, in other embodiments, guiding elements may also be used to provide the curved optical window with curved sides. Yet further, in embodiments, the method may comprise providing the curved optical window with a combination of flat and curved sides. Such embodiments may prevent additional polymeric material from accumulating in the sides of the curved optical window. Furthermore, such embodiments may contact the sides of the curved optical window and hence, prevent slip between the curved optical window and the guiding elements. In embodiments, the method may comprise configuring the one or more guiding elements such that there is no slip between the guiding elements and the curved optical window (or (elongated) polymeric body). Yet further, the method may especially comprise forming a bounded opening (of desired cross-section) by contacting the first roller elements and the guiding elements, such that the extruded curved optical window has the same desired cross-section.

In embodiments, the method may comprise maintaining the rotational speeds of the first roller elements the same. Maintaining the same rotational speed may result in an equal amount of polymeric material (or (elongated) polymeric body) being transported at the vicinity of the one or more first roller elements. Hence, in embodiments, the method may provide a curved optical window that may have no curvature in the vertical direction (when viewed from the front), by maintaining the rotational speed of the first roller elements the same. Alternatively, in embodiments, the method may provide a curved optical window, wherein the curved optical window may be curved upwards by increasing the rotational speed of the first roller element contacting the bottom surface of the (elongated) polymeric body. In a similar way, the method may especially provide a curved optical window, wherein the curved optical window may be curved downwards by increasing the rotational speed of the first roller element contacting the top surface of the (elongated) polymeric body.

In embodiments, the polymeric material may have a glass transition temperature T_{g}. Here, transition is the gradual change in the state of matter (that occurs in amorphous materials), wherein the material (such as the polymer material) may change from relatively hard and brittle state to a relatively viscous and rubbery state. The temperature range over which this occurs may be defined as the glass transition temperature T_{g}. This temperature range T_{g} is lower than the melting temperature Tₘ which is the temperature at which matter changes from a solid state to a liquid state. Hence, in embodiments, the method may comprise heating the (elongated) polymeric body to a processing temperature Tₚ above the glass transition temperature T_{g}, wherein 0 °C.≤Tₚ-T_{g}≤50 ° C. Heating the (elongated) polymeric body may make the polymeric material more ductile and/or malleable, hence reducing the torque required to transform the (elongated) polymeric body to the curved optical window. Hence, especially, the method may comprise heating the polymeric material to a processing temperature Tₚ, wherein Tₚ is higher than the glass transition temperature T_{g}, but not higher than 50 °C above the glass transition temperature T_{g}. Especially, the method may comprise heating the (elongated) polymeric body by means of heating the one or more first roller elements. Additionally or alternatively, in embodiments, the method may comprise heating the polymeric material (i.e. the (elongated) polymeric body or the curved optical window) by means of blowers.

In embodiments, the polymeric material may comprise one or more of PMMA and PC. Further, in embodiments, the polymeric material may comprise (thermoplastic) polymers selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Elastomers, especially thermoplastic elastomers, may especially be interesting as they are flexible. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetra-fluoroethylenes, and their copolymers, for example ethylene-alpha-olefin copolymers), polyoxadiazoles, polyoxymethylenes, polyphthalides, polysilazanes, polysiloxanes, poly-styrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the polymeric material may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

In embodiments, the (elongated) polymer body may comprise scattering particles embedded therein. Especially, the scattering particles may comprise one or more of inorganic particles (e.g. one or more of the following: TiO2 particles, BaSO4 particles, and Al2O3 particles) and silicone particles. The scattering particles may provide the advantage of scattering light incident on them hence, providing diffuse lighting. Hence, in this way, a lighting system that comprises the curved optical window may especially be useful in providing diffuse lighting. In embodiments, the scattering particles may have dimensions (d) selected from the range of 10-10000 nm, such as 20-4000 nm, especially 100-2000 nm, especially 150-1000 nm. Therefore, in embodiments, the curved optical window may comprise a polymeric material with scattering particles embedded therein. The scattering particles may provide the benefit of scattering light incident on these particles and thus, provide diffuse light.

In a further aspect, the invention may provide a curved optical window having a maximum height (hₓ), a minimum height (hₘ), and a radius (r1). Especially, the curved optical window may vary (gradually) in thickness from the left edge to the right edge (when viewed form the front). The radius (r1) is the radius of curvature of the curved optical window, wherein r1 is the curvature of the curved optical window at a point which may be at the center of the cross-section of the curved optical window. In embodiments, the radius r1 may be defined about the centroid of the cross-section of the curved optical window. Therefore, in embodiments, it may be possible to define a radius of curvature at the right and left edge of the curved optical window, wherein the maximum radius is rₓ and the minimum radius is rₘ. The thickness of the curved optical window may especially vary (i.e. increase) gradually from one edge to the other according to 0.75hₘ/hₓ<1, such as 0.75≤hₘ/hₓ<0.95, especially 0.8≤hₘ/hₓ<0.9. Here, hₘ is the minimum thickness and hₓ is the maximum thickness of the curved optical window. Note that hₘ/hₓ cannot be equal to 1 i.e. the curved optical window may, in embodiments, not have a uniform thickness. In embodiments, the minimum height (hₘ) may be at a maximum radius (rₓ) larger than the radius (r₁) and the maximum height (hₓ) may be at a minimum radius (rₘ) smaller than the radius (r₁). Especially, the variation in the thickness may be gradual i.e. the variation in thickness may be 30%, such as 20%, especially 10%.

As mentioned before, in embodiments, the variation in the thickness over the cross-section of the optical window may be related to the radius of curvature of the optical window i.e. a decrease in the ratio hₘ/hₓ may be related a decrease in the radius r₁. However, this may be (only) true when the polymeric body has a uniform thickness (over its cross-section). Hence, in other embodiments, the polymeric body may have a wedge-shaped cross-section. Therefore, in such embodiments, by using a polymeric body of non-uniform cross-section (such as wedge-shape), especially, the curved optical window with a nearly uniform cross-section may be provided. In such embodiments, hₘ/hₓ may especially be provided such that 0.95hₘ/hₓ<1, such as 0.95≤hₘ/hₓ<1, especially 0.99≤hₘ/hₓ<1. This may be particularly advantageous in providing a curved optical window with a nearly uniform cross-sectional thickness. Hence, in this way, homogeneous illumination may be provided.

Hence, in specific embodiments, the invention may provide a curved optical window having a maximum height (hₓ), a minimum height (hₘ), and a radius (r1); wherein 0.7≤hₘ/hₓ<1, wherein a thickness (h) of the curved optical window gradually increases from the minimum height (hₘ) to maximum height (hₓ), wherein the minimum height (hₘ) is at a maximum radius (rₓ) larger than the radius (r₁) and wherein the maximum height (hₓ) is at a minimum radius (rₘ) smaller than the radius (r₁); wherein the curved optical window comprises a polymeric material.

In embodiments, the maximum height (hₓ) may be selected from the range of 0.9*1-3 mm, such as 0.8*1-3 mm, especially 0.7*1-3 mm. Especially, the thickness of the curved optical window may vary according to 0.75hₘ/hₓ≤1, such as 0.85≤hₘ/hₓ≤0.95. Further, in embodiments the radius (r1) may be selected to be at least 100 mm, such as at least 150 mm, such as at least 300 mm. In embodiments, the radius (r1) may be selected to be especially at least 1000 mm, such as at least 10000 mm.

In embodiments, the polymeric material may comprise one or more of PMMA and PC, and additionally, in embodiments, the polymeric material may comprise other polymers which are described previously (see further above).

In embodiments, the polymeric material may comprise scattering particles embedded therein. Further, as mentioned previously, in embodiments the scattering particles may comprise one or more of inorganic particles and silicone particles. Especially, the scattering particles may have dimensions (d) selected from the range of 10-10000 nm, such as 20-4000 nm, especially 100-2000 nm, especially 150-1000 nm. In embodiments, the curved optical window may comprise a curved polymeric diffusor. Especially, the curved polymeric diffusor (in embodiments) may comprise the polymeric material with scattering particles embedded therein.

The obtained effect is a light generating system having the advantage of an improved optical performance (e.g. in terms of shape, appearance and/or diffusivity).

In embodiments, the curved optical window may have a first main face and a second main face defining the thickness (h) of the curved optical window. Embodiments of the curved optical window may be configured to transmit the majority of the light incident on the first main face through the optical window and out via the second main face (with minimal change to optical properties of light). This may be advantageous for purposes of high illumination, for example in a workplace. Alternatively, in embodiments, the curved optical window may provide diffuse light via the second main face (especially when the curved optical window comprises scattering particles) such as for lighting walls or corridors. Yet further, in embodiments, the curved optical window may provide a combination of a beam of light as well as diffuse light from different parts of the curved optical window. Hence, in embodiments the optical window may be transparent and may in other embodiments be translucent.

Hence, in embodiments, under perpendicular radiation of one of the first main face and the second main face with light in the visible wavelength range, at least 85%, such 90%, especially 95%, more especially 99% of the light may be transmitted (when the curved optical window (or a part of it) is configured to provide a beam of light). Alternatively, in embodiments, under perpendicular radiation of one of the first main face and the second main face with light in the visible wavelength range at least 5%, such as 15%, especially 25% of the light is reflected and at least 20%, such as 30%, such as 50%, especially 70% of the light is transmitted (when the curved optical window (or a part of it) is configured to provide diffuse light). Here, in embodiments, a fraction of the light incident on the first main face of the curved optical window may be reflected, and another fraction of the light incident on the first main face of the curved optical window may be transmitted. Further, in embodiments, the transmitted light may undergo scattering within the curved optical window, especially in the presence of scattering particles.

In a further aspect, the invention may provide a light generating system comprising a housing and a light generating device. Especially, the housing may comprise a (curved) light exit window. The light generating system may especially comprise one or more light generating devices configured within the light generating system. The number of light generating devices may vary in embodiments. Further, in embodiments, the one or more light generating devices may be configured to generate device light. Especially, device light may be light in the visible wavelength range. However, in embodiments, the one or more light generating devices may be configured to provide device light in the infrared wavelength range. This may be useful in embodiments which may be used for local heating or warming purposes. Yet further, in embodiments, the one or more light generating devices may generate device light in the ultraviolet wavelength range. This may be useful in embodiments that may be configured to be used for disinfection purposes. In embodiments, the light generating system may comprise a light exit window. Especially, the device light may escape the light generating system via a light exit window. Especially, the light exit window may comprise the curved optical window. In embodiments, the light exit window may be configured to transmit at least part of the device light (to external of the housing) and to reflect at least part of the device light.

Further, in embodiments, the light generating system may comprise one or more optical windows. In specific embodiments, the light generating system may comprise two optical windows, wherein the first optical window may be a curved polymeric diffuser and the second optical window may be an optical window that is (highly) transmissive for light. Hence, in such embodiments, light may pass via the first optical window, the second optical window and then escape via the light exit window.

Hence, in specific embodiments, the invention may provide a light generating system comprising a housing and a light generating device; wherein the housing comprises a (curved) light exit window; wherein the light generating device is configured to generate device light (having a wavelength in the visible wavelength range), wherein the light exit window comprises the curved optical window as defined before, wherein the light exit window is configured to transmit at least part of the device light (to external of the housing) and to reflect at least part of the device light.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In embodiments, the polymeric material may comprise one or more of PMMA and PC. Especially, the polymeric material may (also) comprise other polymers. Polymeric materials used in embodiments of the curved optical window are discussed further above. In embodiments, the scattering particles may comprise one or more of inorganic particles and silicone particles. Especially, the scattering particles may have dimensions (d) selected from the range of 10-10000 nm, such as 20-4000 nm, especially 100-2000 nm, especially 150-1000 nm.

In embodiments, the curved optical window may have a length of at least 4 meter or at least 8 meter.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

In embodiments, the control system may be configured to control (or operate in a mode of operation), the one or more sets of light generating devices. Note that the control system mentioned herein may be different from the control system described previously (which is used to control the system to provide the curved optical window).

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, which can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In yet a further aspect, the invention also provides a lamp or a luminaire comprising the light generating system as defined herein. The luminaire may further comprise a housing, optical elements, louvres, etc. etc . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a light generating device selected from the group of a lamp, a luminaire, a projector device, a disinfection device, a photochemical reactor, and an optical wireless communication device, comprising the light generating system as defined herein. The light generating device may comprise a housing or a carrier, configured to house or support, one or more elements of the light generating system, and e.g. the curved optical window.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-B schematically depict embodiments of the system 2000.

FIG. 2 schematically depicts an embodiment of the curved optical window 400.

FIG. 3 depicts embodiments of the system 2000 where the (elongated) polymeric body 1400 is transported through the first roller elements 410 to provide the curved optical window 400.

FIG. 4 schematically depicts an embodiment of the light generating system 1000.

FIG. 5 schematically depicts an embodiment of the lighting device 1200 comprising the light generating system 1000. The schematic drawings are not necessarily to scale.

### DETAILED DESCRIPTION OF THE EMBODIMENTS

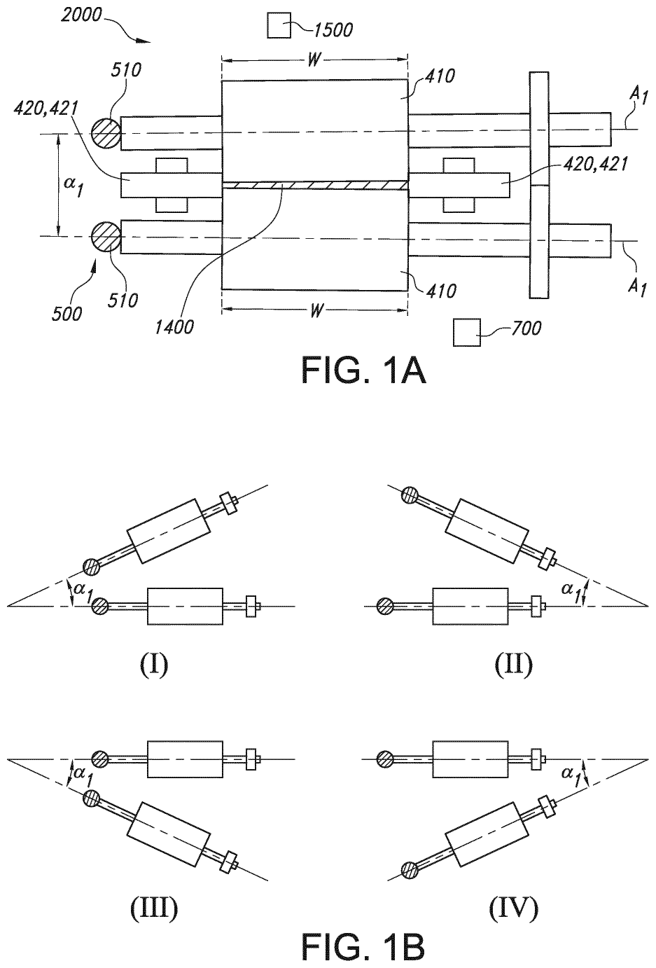

FIG. 1A schematically depicts an embodiment of the system 2000. Especially, the invention may provide a system 2000 for the production of a curved optical window 400 from an (elongated) polymeric body 1400. In embodiments, the system 2000 may comprise a set of first roller elements 410, an actuator system 500, a heating system 700, and a control system 1500.

Especially, the first roller elements 410 may have rotational axes A1 (wherein the first roller elements 410 are configured tiltable), wherein the rotational axes A1 have a controllable mutual angle α1. Further, in embodiments, the actuator system 500 may be configured to control (i) the mutual angle α1 and (ii) a rotational speed of at least one of the first roller elements 410. The system 2000 may especially comprise one or more actuators 510 which may control the rotational speed, or torque, or the mutual angle. In embodiments, the actuators 510 may be controlled by the actuator system 500. Further, in embodiments, the heating system 700 may be configured to heat the (elongated) polymeric body 1400. In embodiments, the control system 1500 is configured to control the actuator system 500 and the heating system 700 such that at least part of the (elongated) polymeric body 1400, while being transported between the first roller elements 410, is heated (with the heating system 700) and bent (especially by controlling the mutual angle α1 and the rotational speed) into the curved optical window 400.

In embodiments, the control system 1500 may be configured to control the actuator system 500 and the heating system 700 such that at least part of the (elongated) polymeric body 1400, having a thickness h₁, while being transported between the first roller elements 410, is heated and bent into the curved optical window 400 having a radius r₁, a maximum height hₓ at a minimum radius rₘ smaller than the radius r₁, and a minimum height hₘ at a maximum radius rₓ larger than the radius r₁; wherein 0.9≤hₓ/h1≤1, and wherein 0.7≤hₘ/hₓ≤1.

In embodiments, the system 2000 may further comprise one or more guiding elements 420. Especially, the guiding elements 420 may be configured at one or both sides of the set of first roller elements 410. In embodiments, the one or more guiding elements 420 may comprise guiding rollers 421. Especially, the guiding elements 420 and the first roller elements 410 may especially form a bounded opening defining a cross-section, wherein the curved optical window 400 transported downstream of the first roller elements may comprise this cross-section.

Especially, the first roller elements 410 and/or the actuator system 500 may be configured such that the rotational speeds of the first roller elements 410 of the system 2000, when in operation, are the same. More especially, the heating system 700 may be configured to heat the first roller elements 410 (and optionally the one or more guiding elements 420).

In a further aspect, the invention may provide a method for the production of a curved optical window 400 from an (elongated) polymeric body 1400, using a set of first roller elements 410. Especially, the first roller elements 410 may have rotational axes A1 (wherein the first roller elements 410 may be configured tiltable). More especially, the rotational axes A1 may have a controllable mutual angle α1.

In embodiments, the method comprises transporting the (elongated) polymeric body 1400 between the first roller elements 410 and heating the (elongated) polymeric body 1400 between the first roller elements 410, controlling (i) the mutual angle α1 and (ii) a rotational speed of at least one of the first roller elements 410, to provide the curved optical window 400. Further, in embodiments, the (elongated) polymeric body 1400 may have a thickness h₁. Especially, the method may comprise transporting the (elongated) polymeric body 1400 between the first roller elements 410 and heating the (elongated) polymeric body 1400 between the first roller elements 410, controlling (i) the mutual angle α1 and (ii) the rotational speed of at least one of the first roller elements 410, to provide the curved optical window 400 having a radius r1, a maximum height hₓ at a minimum radius rₘ smaller than the radius r₁, and a minimum height hₘ at a maximum radius rₓ larger than the radius r₁, wherein 0.9≤hₓ/h1≤1, and wherein 0.7≤hₘ/hₓ<1.

Further, in embodiments, the method may further comprise using one or more guiding elements 420 configured at one or both sides of the set of first roller elements 410. More especially, the one or more guiding elements 420 may comprise guiding rollers 421.

In embodiments, the method may comprise maintaining the rotational speeds of the first roller elements 410 the same. Especially, the (elongated) polymeric body 1400 may comprise a polymeric material 1401 with scattering particles 1402 embedded therein. More especially, the polymeric material 1401 may have a glass transition temperature T_{g}, wherein the method comprises heating the (elongated) polymeric body 1400 to a processing temperature Tₚ above the transition temperature T_{g}, wherein 0 ° C.<Tₚ−T_{g}≤50 ° C.

Especially, the polymeric material 1401 may comprise one or more of PMMA and PC. Furthermore, in embodiments, the scattering particles 1402 may comprise one or more of inorganic particles and silicone particles. Especially, the scattering particles 1402 may have dimensions (d) selected from the range of 20-4000 nm (especially 100-2000 nm). Yet further, in embodiments, the method comprises heating the first roller elements 410.

FIG. 1B schematically depicts embodiments of the system. Especially, configurations of the first roller elements in embodiments is depicted.

The method may provide a curved optical window, in embodiments, wherein hₓ/h₁=1 and wherein 0.85≤hₘ/hₓ≤0.95. Especially, the thickness h₁ may be selected from the range of 1-3 mm. Further, in embodiments, the method may comprise controlling the mutual roller angle α1 between +2 ° and −2 ° relative to parallel configured rotational axes A1. In embodiments, the method may comprise controlling the mutual angle α1 and the rotational speed of at least one of the first roller elements 410 to provide the radius r1 selected to be at least 100 mm, such as at least 150 mm, such as at least 300 mm, such as especially 1000 mm, such as at least 10000 mm.

In embodiments, the method may comprise controlling the mutual roller angle α1 between +5 °, such as +2 °, especially +1 °and −5 °, especially −2 °, such as −1 ° relative to parallel configured rotational axes A1. The definitions of the positive and negative angles are described further above. Hence, in embodiments, the method may comprise controlling the direction of curvature of the curved optical window 400 by varying between the positive and negative mutual roller angle α1. Furthermore, the method may comprise controlling the radius of curvature of the curved optical window by varying the mutual roller angle α1. A larger mutual roller angle α1 may result in a smaller radius r1 of the curved optical window.

Hence, embodiment (I) depicts an embodiment where the “second” first roller element 410 is configured at a positive angle α1 relative to the “first” first roller element 410. Embodiment (II), depicts an embodiment where the “second” first roller element 410 is configured at a negative angle α1 relative to the “first” first roller element 410. Embodiment (III) depicts an embodiment where the “first” first roller element 410 is configured at a positive angle α1 relative to the “second” first roller element 410. Embodiment (III) depicts an embodiment where the “first” first roller element 410 is configured at a positive angle α1 relative to the “second” first roller element 410.

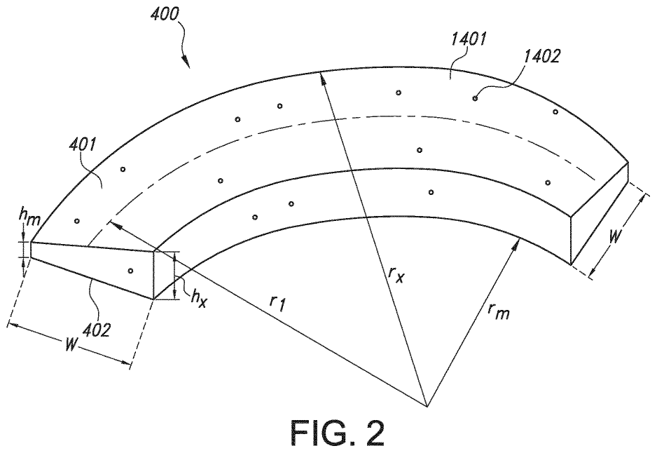

FIG. 2 schematically depicts an embodiment of the curved optical window 400. In a further aspect, the invention provides a curved optical window 400 having a maximum height hₓ, a minimum height hₘ, and a radius r1. Especially, 0.7≤hₘ/hₓ<1, wherein a thickness h of the curved optical window 400 gradually increases from the minimum height hₘ to maximum height hₓ, wherein the minimum height hₘ is at a maximum radius rₓ larger than the radius r₁ and wherein the maximum height hₓ is at a minimum radius rₘ smaller than the radius r₁. Especially, the curved optical window 400 may comprise a polymeric material 1401 with scattering particles 1402 embedded therein. In embodiments, the maximum height hₓ is selected from the range of 0.9*1-3 mm. More especially 0.85≤hₘ/hₓ≤0.95. Especially, the curved optical window may have a width W which may be equal to the difference in the maximum and minimum radius of the curved optical window i.e. W=rₓ-rₘ. Note that, the width of the curved optical window may especially be equal to the width of the first roller elements.

Further, in embodiments, hₓ/h₁=1 and wherein 0.85≤hₘ/hₓ≤0.95. Especially, the mutual roller angle α1 may be controllable between +2 ° and −2 ° relative to parallel configured rotational axes A1. Especially, the thickness h₁ may be selected from the range of 1-3 mm.

Further, in embodiments, the radius r1 may be selected to be at least 100 mm, such as at least 150 mm. Especially, the polymeric material 1401 may comprise one or more of PMMA and PC. More especially, the scattering particles 1402 may comprise one or more of inorganic particles and silicone particles, wherein the scattering particles 1402 have dimensions (d) selected from the range of 20-4000 nm (especially 100-2000 nm,).

In embodiments, the curved optical window 400 may have a first main face 401 and a second main face 402 defining the thickness h of the curved optical window 400. Especially, under perpendicular radiation of one of the first main face 401 and the second main face 402 with light in the visible wavelength range, at least 15% of the light may be reflected and at least 50% of the light may be transmitted. Note that, in embodiments, the extent of light reflected or transmitted may be varied in dependence of the choice of polymeric material. In embodiments, wherein the curved optical window (or part of it) is configured to provide a beam of light (such as for illumination) the transmissivity of the polymeric material may (even) be at least 85%, such as at least 90%, especially at least 95%, more especially at least 99%. Consequently, the extent of light reflected in such embodiments may be at most 15%, such as at most 10%, especially at most 5%, more especially at most 1%.

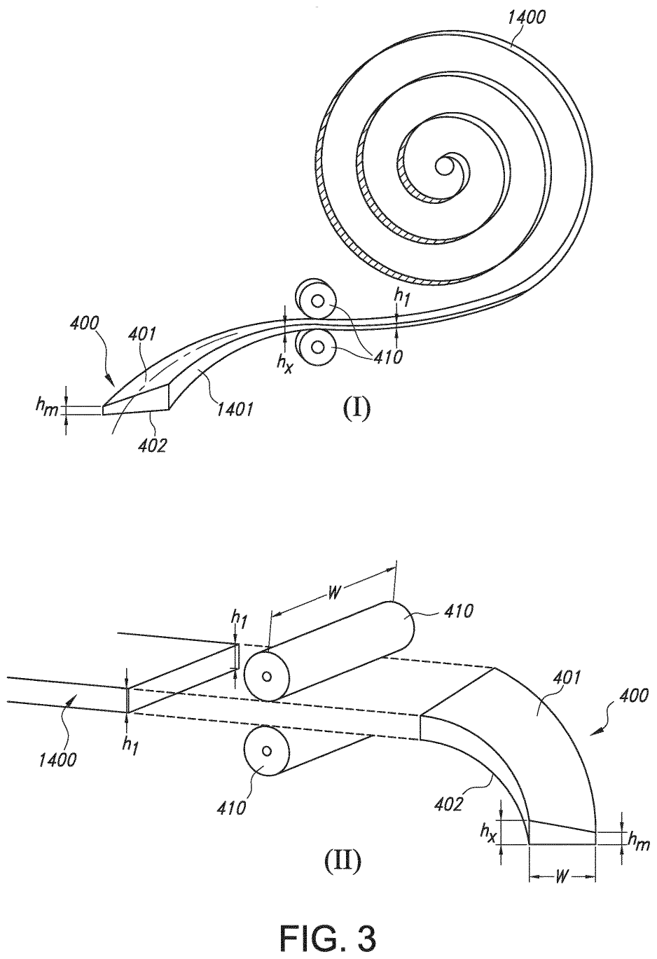

FIG. 3 schematically depicts embodiments of the system 2000 wherein the (elongated) polymeric body 1400 may be transported downstream of the first roller elements 410 to provide the curved optical window 400.

Embodiment I schematically depicts an embodiment wherein the (elongated) polymeric body 1400 may be configured in a spool or coil of polymeric material. Especially, the (elongated) polymeric body 1400 may comprise polymeric material 1401. Further, in embodiments, the polymeric material may comprise scattering particles embedded therein. This may be advantageous in scattering light such as in an embodiment of the curved optical window which comprises the curved polymeric diffuser. However, in other embodiments, the curved optical window may not have embedded particles, such as in a transparent curved optical window. In embodiments, the first roller elements 410 may have a controllable mutual angle α1 (as indicated in FIG. 1b). Hence, in embodiments, the curved optical window may be provided by transporting the (elongated) polymeric body downstream of the first roller elements. Especially, the curved optical window 400 may have a maximum height hₓ at a minimum radius rₘ smaller than the radius r₁, and a minimum height hₘ at a maximum radius rₓ larger than the radius r₁. In embodiments, 0.9≤hₓ/h₁≤1. Further, in embodiments 0.75hₘ/hₓ≤1.

Embodiment II schematically depicts an embodiment wherein the (elongated) polymeric body 1400 may be configured essentially flat or straight (i.e. the (elongated) polymeric body may comprise a rectilinear axis). As described in embodiment I, the (elongated) polymeric body 1400 may be transported downstream of the first roller elements 410 to provide the curved optical window 400. Especially, the curved optical window may have a first main face 401 and a second main face 402. More especially, the first roller elements 410 may have a controllable mutual angle (α1) such that the curved optical window with a radius r1 may be provided. Especially, the curved optical window 400 may have a maximum height hₓ at a minimum radius rₘ smaller than the radius r₁, and a minimum height hₘ at a maximum radius rₓ larger than the radius r₁. Further, in embodiments, the curved polymeric window may have a width W=rₓ-rₘ. In this embodiment, the curved optical window may not have particles embedded therein.

Yet further, the control system 1500 may, in embodiments, be configured to control the actuator system 500 such that the radius r1 is at least 150 mm.

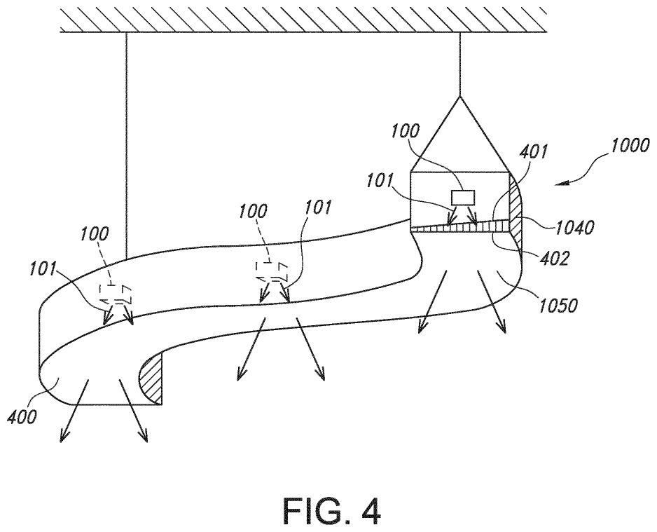

FIG. 4 schematically depicts an embodiment of the light generating system 1000. In a further aspect, the invention may provide a light generating system 1000 comprising a housing 1040 and a light generating device 100. Especially, the housing 1040 may comprise a (curved) light exit window 1050. More especially, the light generating device 100 may be configured to generate device light 101 (having a wavelength in the visible wavelength range).

Further, in embodiments, the light exit window 1050 may comprise the curved optical window 400, wherein the light exit window 1050 may be configured to transmit at least part of the device light 101 (to external of the housing 1040) and to reflect at least part of the device light 101.

Furthermore, the polymeric material 1401 may, in embodiments, comprise one or more of PMMA and PC. Especially, the scattering particles 1402 may comprise one or more of inorganic particles and silicone particles, wherein the scattering particles 1402 may have dimensions (d) selected from the range of 20-4000 nm (especially 100-2000 nm).

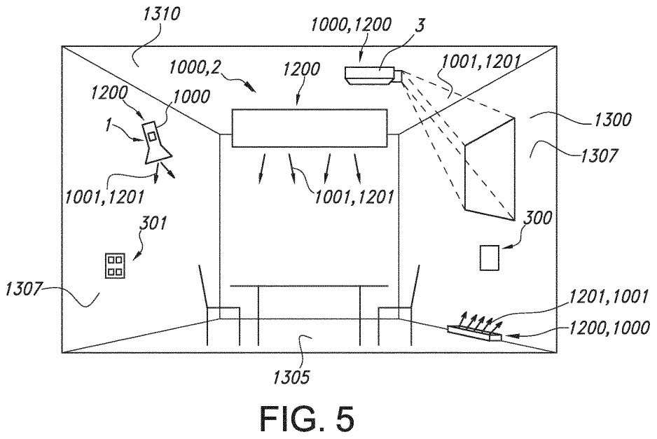

FIG. 5 schematically depicts an embodiment of a luminaire 2 comprising the light generating system 1000 as described above. Reference 301 indicates a user interface which may be functionally coupled with the control system 300 comprised by or functionally coupled to the light generating system 1000. Note that the control system 300 in embodiments may be used to control the light generating system (which is different from the control system 1500 (which may be used by the system 2000 to provide the curved optical window)). Hence, FIG. 5 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. In embodiments, the light generating device 1200 may be configured provide system light 1001 on one or more surfaces in a room 1300. Especially, the light generating system 1000 may illuminate the walls 1307, or the floor 1305, or the ceiling 1310 in a room 1300.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising a housing and a light generating device; wherein the housing comprises a light exit window wherein the light generating device is configured to generate device light, wherein the light exit window comprises a curved optical window, wherein the light exit window is configured to transmit at least part of the device light and to reflect at least part of the device light;
wherein the curved optical window having a maximum height (hₓ), a minimum height (hₘ), and a radius (r1); wherein 0.7≤hₘ/hₓ<1, wherein a thickness (h) of the curved optical window gradually increases from the minimum height (hₘ) to maximum height (hₓ), wherein the minimum height (hₘ) is at a maximum radius (rₓ) larger than the radius (r₁) and wherein the maximum height (hₓ) is at a minimum radius (rₘ) smaller than the radius (r₁); wherein the curved optical window comprises a polymeric material; and
wherein the curved optical window comprises a curved polymeric diffusor.

2. The light generating system according to claim 1, wherein the polymeric material comprises one or more of PMMA and PC.

3. The light generating system according to claim 1, wherein the curved polymeric diffusor comprises the polymeric material with scattering particles embedded therein.

4. The light generating system according to claim 3, wherein the scattering particles comprise one or more of inorganic particles and silicone particles.

5. The light generating system according to claim 4, wherein the inorganic particles comprises one or more of the following: TiO2 particles, BaSO4 particles, and Al2O3 particles.

6. The light generating system according to claim 1, wherein the scattering particles have dimensions (d) selected from the range of 20-4000 nm.

7. The light generating system according to claim 1, wherein the polymeric material comprises one or more of PMMA and PC; wherein the curved polymeric diffusor comprises the polymeric material with scattering particles embedded therein; wherein the scattering particles comprise one or more of inorganic particles and silicone particles, wherein the scattering particles have dimensions (d) selected from the range of 20-4000 nm.

8. The light generating system according to claim 1, wherein the maximum height (hₓ) is selected from the range of 0.9*1-3 mm.

9. The light generating system according to claim 1, wherein 0.85≤hₘ/hₓ50.95.

10. The light generating system according to claim 1, wherein the radius (r1) is selected to be at least 150 mm.

11. The light generating system according to claim 1, wherein the maximum height (hₓ) is selected from the range of 0.9*1-3 mm; wherein 0.85≤hₘ/hₓ≤0.95; and wherein the radius (r1) is selected to be at least 150 mm.

12. The light generating system according to claim 1, wherein the curved optical window has a first main face and a second main face defining the thickness (h) of the curved optical window wherein under perpendicular radiation of one of the first main face and the second main face with light in the visible wavelength range, at least 15% of the light is reflected and at least 50% of the light is transmitted.

13. The light generating system according to claim 1, wherein the curved optical window may have a meandering configuration, wherein the axis of the curved optical window may comprise a number of curves.

14. The light generating system according to claim 1, wherein the curved optical window has a length of at least 4 meters.

15. A lighting device selected from the group of a lamp (1), and a luminaire (2), comprising the light generating system according to claim 13.
